(19) United States
(12) Patent Application Publication
(10) Pub. No.: US 2003/0177224 A1
(43) Pub. Date: Sep. 18, 2003

(54) Clustered/fail-over remote hardware management system

(76) Inventor: Minh Q. Nguyen, Milpitas, CA (US)

Correspondence Address: HEWLETT-PACKARD COMPANY, Intellectual Property Administration, P.O. Box 272400, Fort Collins, CO, 80527-2400, US

(21) Appl. No.: 10/097,371

(22) Filed: Mar. 15, 2002

(51) Int. Cl. G06F 15/173

(52) U.S. Cl. 709/224; 714/13

(57) ABSTRACT

A system and corresponding method for providing clustered/fail-over remote hardware management includes a plurality of servers, each having one or more hardware devices. The servers includes a home server and one or more neighboring servers. The home server includes one or more native embedded remote assistants (ERAs) capable of monitoring the hardware devices in the home server, and each neighboring server includes one or more backup ERAs. The clustered/fail-over system further includes a remote management station (RMS) coupled to the native ERA and the backup ERAs, and capable of remotely managing operation of the plurality of servers. Each native ERA is also monitored by the backup ERAs for failure. If one of the native ERAs fails, the backup ERAs monitors the hardware devices in the home server, and reports failure of the hardware devices to the RMS.

### TECHNICAL FIELD

The technical field relates to computer hardware management system, and, in particular, to clustered/fail-over remote hardware management system.

### BACKGROUND

An embedded remote assistant (ERA) is a hardware module installed in a computer server to enable users to remotely monitor and manage the server's operation. To perform remote monitor or control function, the ERA is typically installed in each server and connected to the server's hardware through I²C, and ISA/PCI buses. Through the buses, ERA collects server operational status and forwards the status to a remote management station (RMS) through RS-232 buses, modem and/or phone lines.

In current ERA non-clustered systems with multiple servers, each server is equipped with a native ERA. Each native ERA monitors its home server's hardware individually, and is not backed up by any other monitoring means. With this setting, the task of remote hardware management for a server only functions when the native ERA is working. If the native ERA is inoperative, the server is disconnected from the RMS, and all remote management tasks, such as remote control, monitoring, diagnosis, and critical event notification, for example, are disabled regardless of the server's status. In addition, when the ERA fails to function, no means exist to notify the RMS about the failure.

### SUMMARY

A system and corresponding method for providing clustered/fail-over remote hardware management includes a plurality of servers, each server having one or more hardware devices. The plurality of servers includes a home server and one or more neighboring servers. The home server includes one or more native embedded remote assistants (ERAs), and each native ERAs includes a first monitoring module. Each native ERA monitors the hardware devices in the home server using the first monitoring module. Each neighboring server includes one or more backup ERAs, and each backup ERAs includes a second monitoring module. The system further includes a remote management station (RMS) coupled to the native ERAs and the backup ERAs. The RMS is capable of remotely managing operation of the plurality of servers. The backup ERAs in the neighboring servers monitor each native ERA using the second monitoring module.

The cross monitoring function of the clustered/fail-over remote hardware management system enables a server to monitor every device, including the native ERA, without interruption. In addition, the system provides uninterrupted remote monitoring and management service of devices in the server, regardless of working status of each individual ERA.

### DESCRIPTION OF THE DRAWINGS

The preferred embodiments of the method and apparatus for providing clustered/fail-over remote hardware management will be described in detail with reference to the following figures, in which like numerals refer to like elements, and wherein:

FIGS. 1A and 1B illustrate an exemplary clustered/fail-over remote hardware management system;

FIGS. 2A and 2B illustrate an exemplary architecture of an ERA used by the exemplary clustered/fail-over remote hardware management system;

FIGS. 3A-3C depict the exemplary clustered/fail-over remote hardware management system's three different modes of operation;

FIG. 4 is a flow chart illustrating the exemplary clustered/fail-over remote hardware management system;

FIG. 5 illustrates an exemplary “Arm hearbeat_timer interrupt” task used by the clustered/fail-over remote hardware management system; and

FIG. 6 illustrates exemplary hardware components of a computer that may be used in connection with the method for providing clustered/fail-over remote hardware management.

### DETAILED DESCRIPTION

An embedded remote assistant (ERA) is a hardware module typically installed in a computer network server to enable network users or technicians to remotely monitor and manage the server's operation. The ERA reduces server maintenance cost, and maximizes server reliability and availability at remote sites.

The ERA is described as a server hardware monitoring module in the description and corresponding examples. However, one skilled in the art will appreciate that the design concept can be extended to application that uses different monitoring modules, such as AGILENT REMOTE MANAGEMENT CARD (RMC)®, EMBEDDED REMOTE MANAGEMENT CARD (ERMC)®, DELL REMOTE ASSISTANT CARD (DRAC)®, COMPAQ REMOTE INSIGHT LIGHTS-OUT EDITION (EILOE)®, or other monitoring modules. Similarly, the clustered/fail-over remote hardware management system can use different remote transmission medium other than RS232/phone-line, such as Ethernet/LAN/WAN, for implementation.

A clustered/fail-over remote hardware management system provides an array of ERA modules with one ERA module installed in each network server, to remotely monitor the server's hardware resources and operating conditions. The ERA modules also perform remote server control functions. In the clustered/fail-over configuration, each ERA is monitored by other ERAs in neighboring servers. Multiple backup configurations may be provided with additional cost.

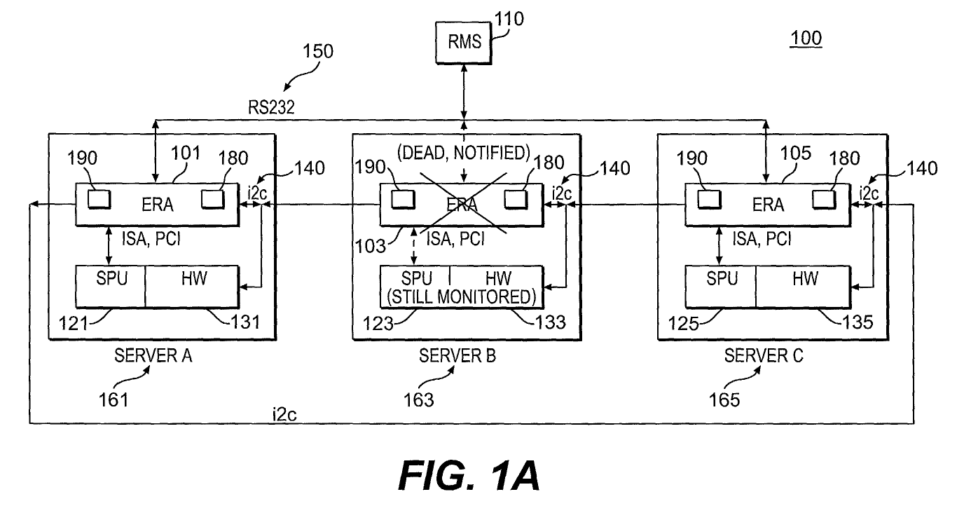

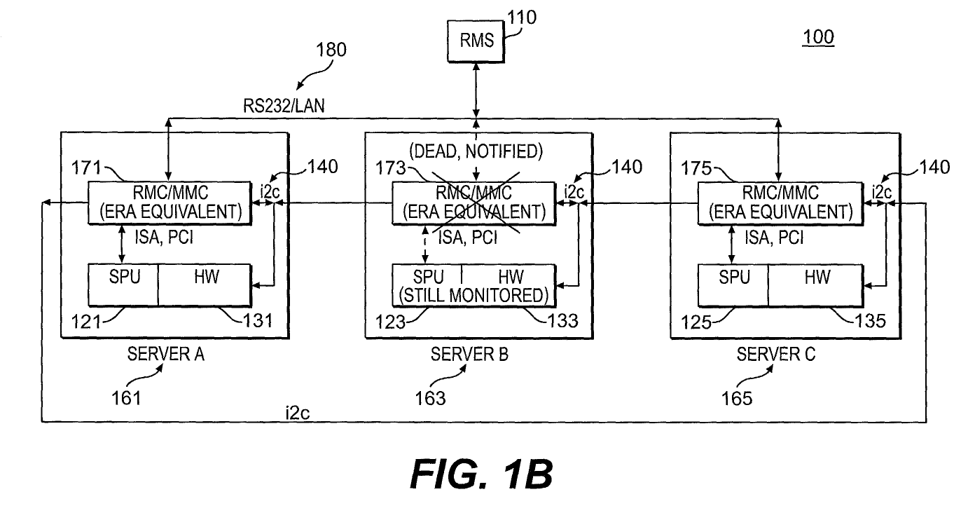

FIG. 1A illustrates an exemplary clustered/fail-over remote hardware management system 100. Server A 161, server B 163, and server C 165, are typically computer network servers. Each server typically includes hardware devices, such as system processor units (SPUs) 121, 123, 125, and hardware (HW) 131, 133, 135. Examples of SPUs include central processing units (CPUs) and memories. Examples of HW include hard drives, monitors, and keyboards. ERAs 101, 103, 105 are typically installed in the servers 161, 163, 165, respectively, and connected to the SPU 121, 123, 125 and the HW 131, 133, 135, respectively, through an ISA/PCI bus.

The ERA 101, 103, 105 in each home server 161, 163, 165 typically includes a monitoring module 180 (first monitoring module), and periodically checks the home server's SPU 121, 123, 125 and HW 131, 133, 135 for failures using the first monitoring module 180, i.e., collecting home server operational status. If failure occurs in the SPU 121, 123, 125 or HW 131, 133 135, the ERA 101, 103, 105 reports the failure to a remote management station (RMS) 110 through RS232 buses, and/or phone lines 150. Depending on the detail of the failure, the ERA 101, 103, 105 typically generates different failure information report. For example, the ERA 101, 103, 105 may monitor temperature or voltage of a hardware device. If the temperature reaches to certain degree, or if the voltage drops to below certain volts, the ERA 101, 103, 105 reports the failures to the RMS 110.

ERAs in different servers are typically interconnected through an Inter IC, i.e., I²C, bus daisy chain 140. Examples of I²C bus 140 specification are described, for example, in “The I²C-Bus and How to Use It,” published in April 1995 in Philips Semiconductors, which is incorporated herein by reference. Each native ERA is monitored by other backup ERAs in neighboring servers using similar monitoring modules 190 (second monitoring module), so that ERA failure can be detected and reported promptly to prevent monitoring blackout. Failure of an ERA means that electrically the ERA cannot perform the function of periodically checking the devices for failures. Accordingly, the cross monitoring function of the system 100 enables a server to monitor every device, including the native ERA, without interruption. For example, while monitoring the SPU 125 and the HW 135 of the server C 165, the ERA 105 in the server C 165 monitors the ERA 103 in the server B 163 from time to time. In a similar fashion, the ERA 103 in the server B 163 checks the ERA 101 in the server A 161 for failures. If the ERA of one server fails, for example, the server B's ERA 103 in FIG. 1A, the failure is readily detected and notified to the RMS 110 by, for example, the backup ERA 105 in the neighboring server C 165.

In addition, the clustered/fail-over remote hardware management system 100 provides uninterrupted remote monitoring and management service of devices in the server 161, 163, 165, regardless of working status of each individual ERA 101, 103, 105. After detecting the failure of the native ERA in the home server, the backup ERA typically temporarily takes over and continues monitoring the home server using the second monitoring module 190, while the failed native ERA awaits repair services. Therefore, the system 100 prevents discontinuity of remote server management. During fail-over, task bandwidth of the backup ERA is typically shared between two servers. As a result, the backup ERA's monitoring task may become less responsive. However, low responsiveness in server remote management, particularly in mission critical business, is more tolerable than outright discontinuity or blackout.

For example, after detecting failure of the native ERA 103 of the home server B 163, the backup ERA 105 in the neighboring server C 165 reports the failure to the RMS 110. Then, the backup ERA 105 in the neighboring server C 165 takes over the responsibility of the home ERA 103 in the home server B 163, and starts monitoring the SPU 123 and the HW 133 of the home server B 163. The ERA 105 in the server C 165 typically divides time between monitoring the SPU 125 and the HW 135 in the neighboring server C 165, and the SPU 123 and the HW 133 in the home server B 163.

The I²C daisy chain configuration and ring topology of ERA cluster enables the ERA cluster to be scalable. Using the same ERA hardware for each server, the ERA cluster can be applied to a group of any size, for example, a group of 1000 servers, without extra hardware for interconnection and operation.

FIG. 1B is another embodiment of the clustered/fail-over remote hardware management system 100. The ERAs 101, 103, 105 of FIG. 1A are replaced by a functionally equivalent unit, i.e., remote management control (EMC) or multiple management cards (MMC), 171, 173, 175, respectively. The EMC or MMC communicates with the RMS 110 through either RS232 or local area network (LAN) 180.

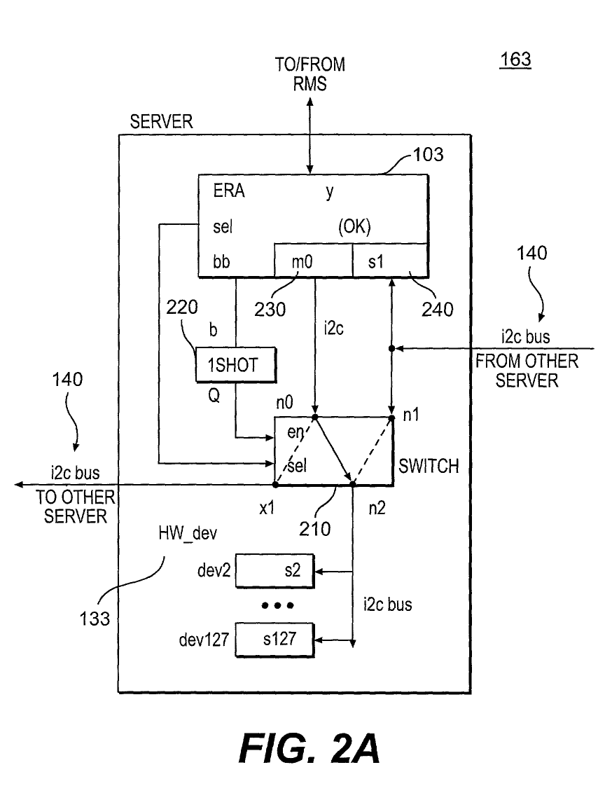

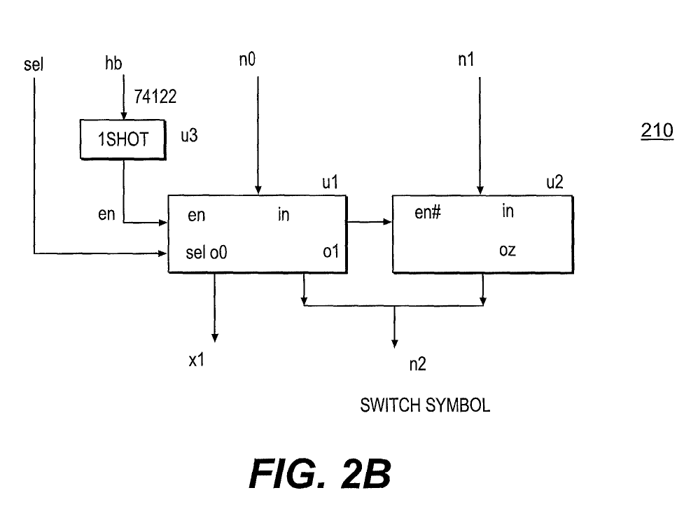

FIG. 2A illustrates an exemplary architecture of the native ERA 103 in the home server 163. Each unit of ERA clustered/fail-over system may have four major components, i.e., the native ERA 103, an one-shot watchdog 220, a matrix switch 210, and the I²C bus 140.

In this example, the native ERA 103 is a micro-controller based monitoring agent that has two I²C ports: one master port 230 and one slave port 240. The native ERA 103 uses address 0 (m0) of the master I²C port 230 to connect to hardware devices 133 to monitor the devices 133. The backup ERAs 135 typically use address 1 (s1) of the native ERA's slave I²C port 240 to monitor the native ERA's working status.

The system 100 uses the one-shot watchdog 220 to detect whether the native ERA 103 is operative or not, and to set the matrix switch 210 to normal mode or failover mode, respectively.

The matrix switch 210 is controlled by both the one-shot watchdog 220 (through its enabled input “en”) and the native ERA 103 (through its select input “sel”). The matrix switch 210 typically has two major modes: normal mode and failover mode.

FIG. 2B illustrates an exemplary implementation of the matrix switch 210. Matrix switch's inputs include “n0”, “n1”, “en”, and “sel”. “n0” is an I²C bus input driven by the native ERA's master I²C port 230; “n1” is an I²C bus input driven by the backup ERA's master I²C port 230; “en” is a digital logic “enable” input that controls (enable or disable) the bus output; and “sel” is a digital logic “select” input that selects the matrix switch's bus output to be connected to the matrix switch's bus input.

The matrix switch's outputs include “x1” and “n2”. “x1” is the matrix switch's I²C bus output connected to neighboring server's hardware devices (including the backup ERAs), and “n2” is the matrix switch's I²C bus output connected to the hardware devices in the home server 163.

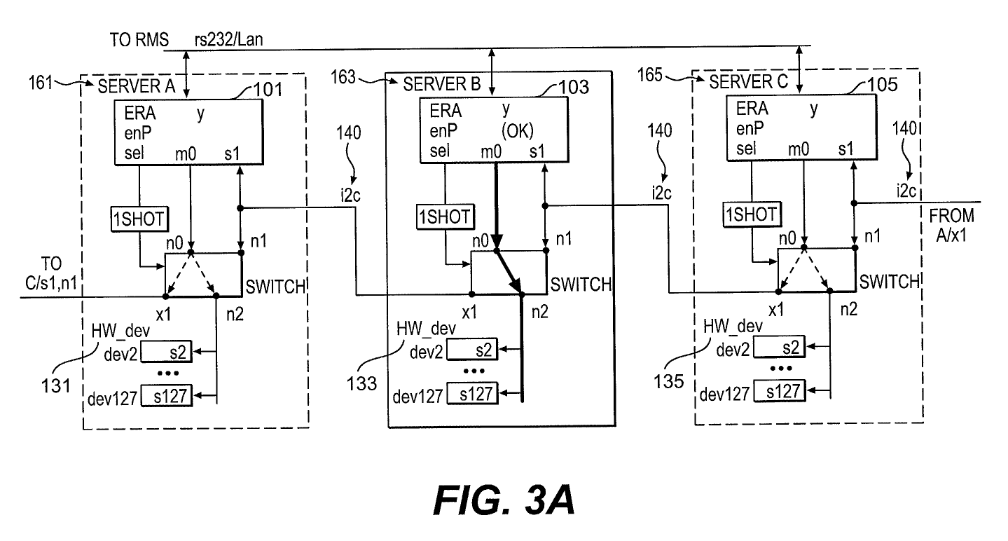

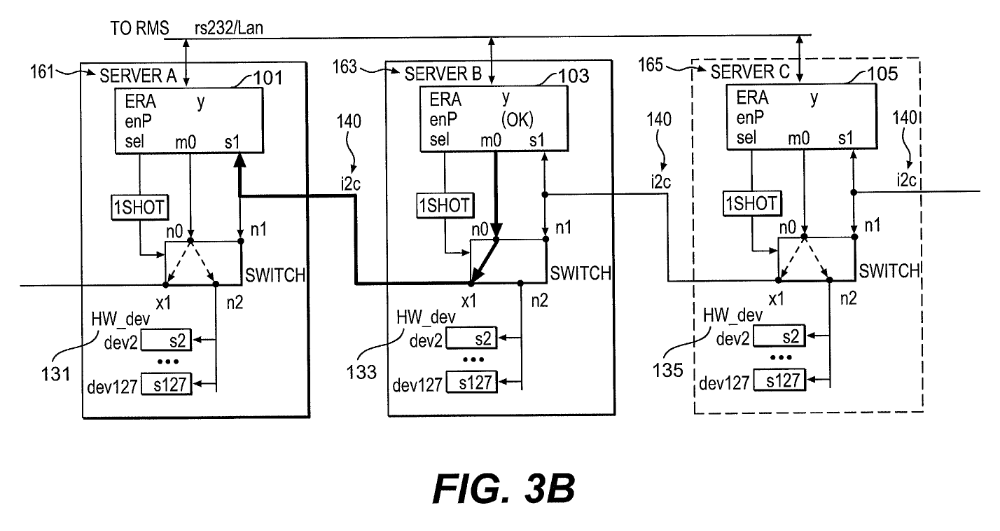

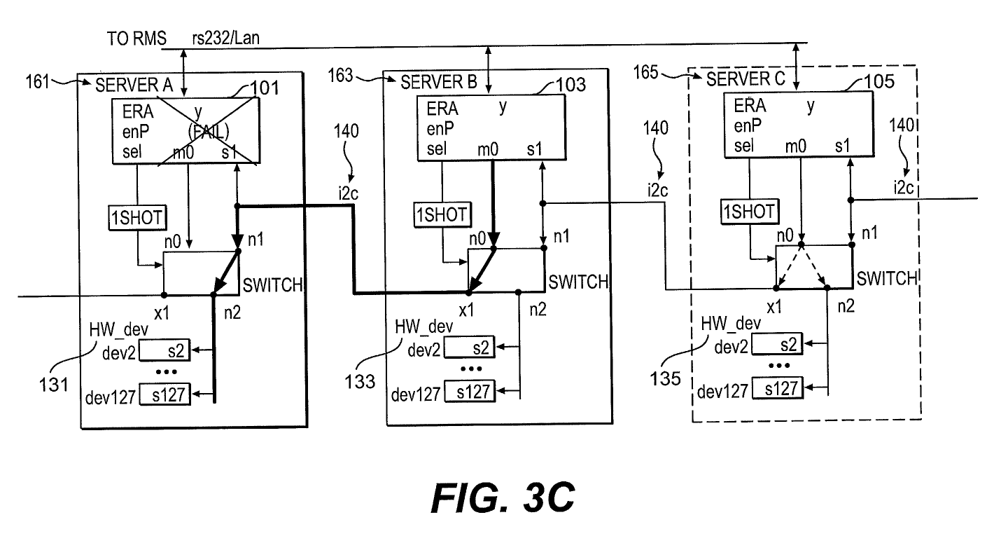

Referring to FIG. 2A, in the normal matrix switch mode, the native ERA 103 is operative, and the matrix switch's input “n0” is controlled by ERA's “sel” and can be connected to the output “n2” or “x1”. When “n0” is coupled to “n2”, the native ERA 103 is connected to the native ERA's hardware devices 133 in the home server 163 for self-monitoring. When “n0” is coupled to “x1”, the native ERA 103 is connected to the hardware devices 131 (shown in FIGS. 1A and 1B) in the neighboring server 161 (shown in FIGS. 1A and 1B), including the backup ERA 101 (shown in FIG. 1A), for cross/take-over monitoring (described in detail with respect to FIGS. 3A and 3B).

In the failover mode, the native ERA 103 has failed. The input “n0”, which is under control of the one-shot watchdog 220, is disconnected from “x1” and “n2”. At the same time, “n1” is connected to “n2”. This setting allows the system devices 133 in the home server 163 to receive failover monitoring provided by the backup ERA 105 (shown in FIG. 1A) in the neighboring server 165 (shown in FIGS. 1A and 1B) (described in detail with respect to FIG. 3C).

I²C bus 140 functions as transport media for the native ERA 103 to connect to the hardware devices 133 in the home server 163 and the hardware devices 131, 135 in the neighboring servers 161, 165. In this example, the allocation of 128 addresses on each server's I²C bus is arranged as follows: 1^{st} address is typically assigned to the master I²C port 230 of the native ERA 103, denoted as “m0”; 2^{nd} address is typically assigned to the slave I²C port 240 of the native ERA 103, denoted as “s1”; and 3^{rd} to 128^{th} addresses are typically assigned to the slave I²C ports of the hardware devices 133 to be monitored, denoted as “s2, . . . , s127”.

FIGS. 3A-3C depict the clustered/fail-over remote hardware management system's three different modes of operation. FIG. 3A illustrates self monitoring mode. For example, the server B's ERA 103 self-monitors the server B's hardware devices 133, using the server B's ERA's master port “m0” and the hardware devices' slave ports “s2, . . . , s127”.

FIG. 3B illustrates cross monitoring mode. For example, the server B's ERA 103 cross-monitors the server A's ERA 101, using the server B's ERA's master port “m0” and the server A's ERA's slave port “s1”.

FIG. 3C illustrates fail-over monitoring mode. For example, the server A's ERA 101 has failed. The ERA's switch 210 is reset automatically to fail-over mode, in which “n0” is disconnected from “x1” and “n2” outputs, and “n1” is connected to “n2”. With this setting, the server B's ERA 103 takes over the task of monitoring the server A's hardware devices 131 using the server B's ERA's mater port and the server A's hardware devices' slave ports.

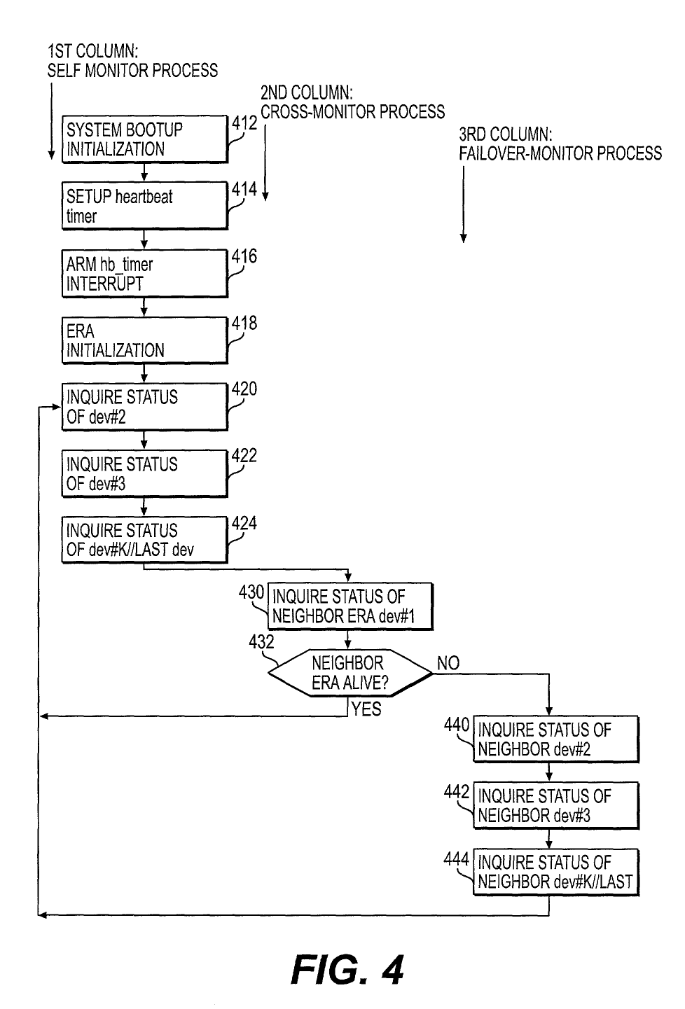

FIG. 4 is a flow chart illustrating the exemplary clustered/fail-over remote hardware management system. In this example, tasks related to self-monitoring are grouped together into a process referred to as self-monitor process, and placed in the left most 1^{st} column. Cross-monitor process and failover-monitor process are placed in the 2^{nd} and 3^{rd} column, respectively. A task of a process can be itself a process of a series of smaller tasks. For illustration purposes only, FIG. 4 only shows high level of processes and tasks.

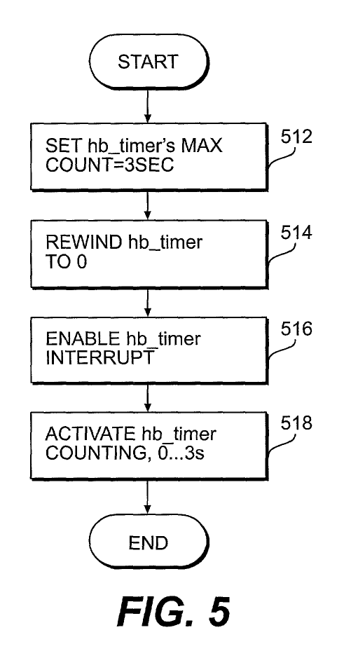

The clustered/fail-over remote hardware management system incorporates the 2^{nd} column and the 3^{rd} column into the 1^{st} column. Referring to the 1^{st} column, the system 100 boots up and initializes (block 412). Next, the system 100 sets up heartbeat timer (block 414, described in detail with respect to FIG. 5). The heartbeat timer interrupt system is well know in the art. Then, Arm hb-timer interrupts (block 416), and the ERA initializes (block 418). The system 100 inquires status of home device #2, device #3, . . . device #K (blocks 420, 422, 424, respectively) in using the first monitoring module 180. After the system 100 checks the last device, the system 100 inquires status of the neighboring ERA device #1 using the second monitoring module 190 (block 430, 2^{nd} column). If the neighboring ERA is operative (block 432), the cycle goes back to block 420. If neighboring ERA has failed (block 432), then the system 100 inquires status of the neighboring hardware device #2, device #3, . . . device #K using the second monitoring module 190 (blocks 440, 442, 444, respectively, 3^{rd} column).

FIG. 5 illustrates an exemplary “Arm hearbeat_timer interrupt” task used by the clustered/fail-over system 100. First, the system 100 sets hb_timer's maximum value to, for example, 3 second (block 512). When the hb_timer is activated, the timer starts counting from rewind value 0 to 1T, 2T and so on (block 514), where T is the ERA's system clock period, typically of few hundred nano-seconds. Eventually the hb_timer will count to a present maximum value, 3 second in this example, which triggers an ERA interrupt (block 516). Upon receiving the interrupt, the ERA 101, 103, 105 suspends any current task to carry out the interrupt service routine (block 518). The interrupt service routine typically sends out a heartbeat (i.e., timer), rewinds and re-activates hearbeat_timer from 1. The interrupt service routine also clears and re-enables the interrupt. After finishing the interrupt routine, the ERA 101, 103, 105 resumes the task that has been suspended by the interrupt.

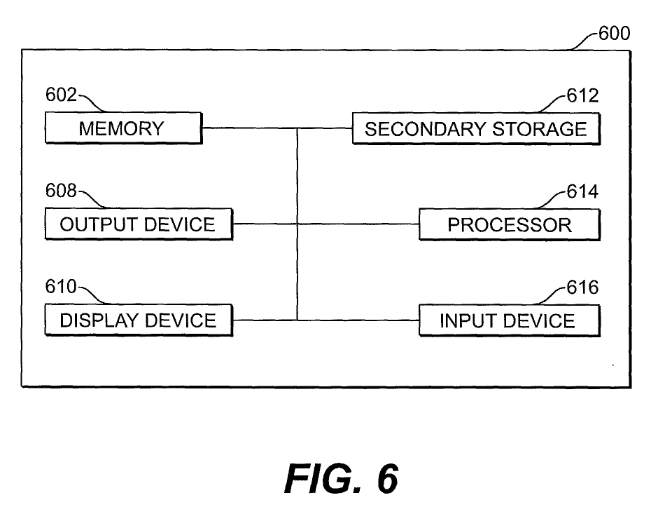

FIG. 6 illustrates exemplary hardware components of a computer 600 that may be used in connection with the method for providing clustered/fail-over hardware management. The computer 600 typically includes a memory 602, a secondary storage device 612, a processor 614, an input device 616, a display device 610, and an output device 608.

The memory 602 may include random access memory (RAM) or similar types of memory. The secondary storage device 612 may include a hard disk drive, floppy disk drive, CD-ROM drive, or other types of non-volatile data storage, and may correspond with various databases or other resources. The processor 614 may execute information stored in the memory 602 or the secondary storage 612. The input device 616 may include any device for entering data into the computer 600, such as a keyboard, keypad, cursor-control device, touch-screen (possibly with a stylus), or microphone. The display device 610 may include any type of device for presenting visual image, such as, for example, a computer monitor, flat-screen display, or display panel. The output device 608 may include any type of device for presenting data in hard copy format, such as a printer, and other types of output devices including speakers or any device for providing data in audio form. The computer 600 can possibly include multiple input devices, output devices, and display devices.

Although the computer 600 is depicted with various components, one skilled in the art will appreciate that the computer 600 can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 600 to perform a particular method.

While the method and apparatus for providing clustered/fail-over hardware management have been described in connection with an exemplary embodiment, those skilled in the art will understand that many modifications in light of these teachings are possible, and this application is intended to cover any variations thereof.

what is claimed is:

1. A clustered/fail-over remote hardware management system, comprising:
a plurality of servers each having one or more hardware devices, wherein the plurality of servers include a home server and one or more neighboring servers, wherein the home server comprises:
one or more native embedded remote assistants (ERAs), each of the one or more native ERAs comprises a first monitoring module, wherein each of the one or more native ERAs monitors the hardware devices in the home server using the first monitoring module,
and wherein each neighboring server comprises:
one or more backup ERAs, each of the one or more backup ERAs comprises a second monitoring module; and
a remote management station (RMS) coupled to the one or more native ERAs and the one or more backup ERAs, wherein the RMS is capable of remotely managing operation of the plurality of servers, and wherein the one or more backup ERAs in the one or more neighboring servers monitor each native ERA using the second monitoring module.

2. The system of claim 1, wherein the hardware devices include system processor units (SPUs).

3. The system of claim 1, wherein the native ERAs reports failure of the hardware devices in the home server to the RMS.

4. The system of claim 1, wherein the one or more backup ERAs in the one or more neighboring servers reports failure of the native ERA to the RMS.

5. The system of claim 1, wherein if one of the native ERAs in the home server fails, the one or more backup ERAs in the one or more neighboring servers monitors the hardware devices in the home server using the second monitoring module.

6. The system of claim 5, wherein the one or more backup ERAs in the one or more neighboring servers reports failure of the hardware devices in the home server to the RMS.

7. The system of claim 5, wherein the one or more backup ERAs use timer interrupt to concurrently monitor hardware devices in the home server and the one or more neighboring servers.

8. A method for providing clustered/fail-over hardware management, comprising:
monitoring hardware devices in a home server by a native embedded remote assistant (ERA) located in the home server; and
monitoring the native ERA for failure by one or more backup ERAs located in one or more neighboring servers, wherein the one or more backup ERAs are coupled to the native ERA.

9. The method of claim 8, further comprising: if the native ERA fails, periodically monitoring the hardware devices in the home server by the one or more backup ERAs in the one or more neighboring servers.

10. The method of claim 8, wherein the monitoring the hardware devices step includes inquiring status of the hardware devices.

11. The method of claim 8, wherein the monitoring the native ERA step includes inquiring status of the native ERA.

12. The method of claim 8, further comprising reporting failure of the hardware devices in the home server by the native ERA to a remote management station (RMS) coupled to the native ERA.

13. The method of claim 8, further comprising reporting failure of the native ERA by the one or more backup ERAs to a remote management station (RMS) coupled to the native ERA and the one or more backup ERAs.

14. The method of claim 8, further comprising: if the native ERA fails, periodically inquiring status of the hardware devices in the home server by the one or more backup ERAs in the one or more neighboring servers.

15. The method of claim 14, further comprising reporting failure of the hardware devices in the home server by the one or more backup ERAs to a remote management station (RMS) coupled to the native ERA and the one or more backup ERAs.

16. A computer readable medium providing instructions for clustered/fail-over hardware management, the instructions comprising:
monitoring hardware devices in a home server by a native embedded remote assistant (ERA) located in the home server; and
monitoring the native ERA for failure by one or more backup ERAs located in one or more neighboring servers, wherein the one or more backup ERAs are coupled to the native ERA.

17. The computer readable medium of claim 16, further comprising instructions for reporting failure of the hardware devices in the home server by the native ERA to a remote management station (RMS) coupled to the native ERA.

18. The computer readable medium of claim 16, further comprising instructions for reporting failure of the native ERA by the one or more backup ERAs to a remote management station (RMS) coupled to the native ERA and the one or more backup ERAs.

19. The computer readable medium of claim 16, further comprising: if the native ERA fails, instructions for periodically inquiring status of the hardware devices in the home server by the one or more backup ERAs in the one or more neighboring servers.

20. The computer readable medium of claim 19, further comprising instructions for reporting failure of the hardware devices in the home server by the one or more backup ERAs to a remote management station (RMS) coupled to the native ERA and the one or more backup ERAs.
